(19) United States
(12) Patent Application Publication
(10) Pub. No.: US 2012/0246089 A1
(43) Pub. Date: Sep. 27, 2012

(54) Method and Apparatus to Enable Safer Meetings and Dates

(75) Inventor: Steven Brian Sikes, Miami, FL (US)

(73) Assignee: VISIONSYNC, INC., Palo Alto, CA (US)

(21) Appl. No.: 13/069,190

(22) Filed: Mar. 22, 2011

(51) Int. Cl. G06Q 99/00; H04M 11/04

(52) U.S. Cl. 705/325; 455/404.1

(57) ABSTRACT

A method and apparatus for verifying persons' profiles that reside within the databases of online dating, location-based and social networking sites, platforms and applications. The method includes an interface for inputting and modifying settings, including inviting selected contacts, transmitting data about the individual whom the user will be meeting, the scheduled date, time and location for the meeting, and messaging delivered at requested times and intervals. Said user also may auto-transmit pre-set messages at determined times, visually record a meeting for real-time delivery to selected contacts, and utilize a Blue-tooth-enabled device to activate a distress signal and messaging via his or her mobile communication device, as well as transmitting pre-created messages to contacts that reside on directories or support workers. The invention also facilitates utilizing nearby user contacts, as a peer-to-peer buddy network, to render aid and to escalate security measures wherein the user may be in distress.

### CROSS-REFERENCE TO RELATED APPLICATIONS

This is an application claiming the benefit of U.S. Provisional Application No. 61/319,121, filed on Mar. 30, 2010, and hereby incorporated by reference herein.

### FIELD OF THE INVENTION

This invention comprises a method and apparatus for facilitating safer dates, meetings and encounters for users who meet in real-time after having connected with persons virtually through online and mobile dating web sites and applications and social media sites and applications, as well as through location-based service applications and platforms.

### DESCRIPTION OF THE RELATED ART

This invention relates to a method and apparatus for users who log into non-downloadable and downloadable applications or websites, select from a plurality of contacts from directories that reside on software, firmware and hardware, including but not limited to email accounts, handheld and mobile communication devices, social media sites, microblogging or location-based service applications and platforms. Users of said system and apparatus shall transmit, via email, chat, calls, or VoIP or text, invitations for selected contacts to be their guardians. After confirmation of accepting their designated roles, the guardians subsequently send texts, transmit messaging or make calls to said users at pre-determined times, while said users are meeting persons in real-time during dates, encounters or meetings at specified locales and venues, with said locales and venues already identified by said users and which may be located via online and mobile mapping applications and geo-targetting and geo-fencing. After receiving confirmation from the selected contacts to be their guardians, said users can adjust settings on a user interface to input data, including but not limited to information, photos, data and details of the persons whom they intend to meet, including, but not limited, to the location and time for the scheduled dates or meetings which the guardians shall store or use for reference or to utilize for safety and security measures. Users also may transmit to their guardians the requested messaging to receive, which may include but not be limited to texts, calls, or chat for the guardians to deliver or perform, at specified times and intervals, to said users during their scheduled dates or meetings, for the purposes of ensuring safety or abbreviating said meetings, dates or encounters. Said users also may set specific times for transmitting the delivery of auto-generated messages, including but not limited to texting or chat, for a plurality of reasons, including but not limited to reminders, alibis, excuses for call-backs, or for reducing the duration of said meetings or encounters.

Said system and apparatus facilitates a buddy or peer-to-peer safety network for users to receive messaging from their contacts or guardians at pre-determined times. Said users subsequently can transmit updates and alerts during their meetings or dates. Said users also may log into their location-based service applications or platforms from their mobile or portable communication devices, including but not limited to laptops, smartphones, and tablets, just prior to actually meeting persons for scheduled dates or encounters, and they can transmit their location to any or all of their plurality of contacts or friends who reside on the directories of said location-based service applications or platforms. Moreover, said users also may log into their microblogging applications or platforms from their portable or mobile communication devices and provide real-time updates to any or all of their plurality of friends, followers, or contacts.

Users of said system and apparatus shall provide personalized messaging and instructions to their guardians, in the event that said users transmit pre-created messages or alerts to any or all of their guardians during the users' said meetings or dates, which may include, but not be limited to, a response or request for the guardians to immediately contact said users, or to facilitate emergency services in the event that the guardian is unable to contact its designated user. Moreover, if after a pre-determined time, and upon the said user's request and instructions, the user has failed to respond to the messaging of the guardians with a notification, update, or a reciprocal message, including but not limited to chat, texting or a call, guardians shall take subsequent action to facilitate the safety of said users during or after the users' dates or encounters, which may include contacting emergency services, calling someone at the venue of the meeting or date, or notifying and alerting friends or contacts who may be in the vicinity of the location or venue of the said user's date or meeting.

### BACKGROUND OF THE INVENTION

There exists a variety of software applications, remote alert activators and safety tools that reside on handheld, mobile and electronic communication devices. These include remote home monitoring systems and apparatuses used mostly by seniors and the elderly, and persons with chronic conditions, as well as tracking software on mobile communication devices used by parents to follow the movements and locations of their children, as well as health-and emergency-related applications on mobile and handheld communication devices that can sound alarms and transmit information to contacts and call centers during critical events.

With the prevalence and burgeoning participation and interaction of members and users on social networking and social media sites such as Facebook, MySpace, Orkut, and Hi5, the surge in online and mobile dating, the increased adoption of location-based service applications such as FourSquare, GoWalla, Loopt, and the exponential growth by users of microblogging platforms like Twitter, users and members of these sites, applications and platforms are taking risks wherein meeting persons whom they have met only virtually, often with either limited or inaccurate information about said individuals.

Users or subscribers of said sites, applications and platforms, who only have met through virtual encounters and interactions, or subsequently through communication via calls, chat, messaging or texting, may face potential risks, dangers, or deceit when meeting these individuals in person at specified and mutually agreed upon locations. Moreover, unscrupulous individuals, including online predators, often target persons whom they have met virtually to arrange encounters or meetings with the intention of committing unethical, offensive, fraudulent or illegal acts.

The majority of users and members of social networking and online dating sites engage in positive and friendly interactions with other members and users, and many close relationships, including marriage and partnerships, are facilitated through these initial virtual and online connections, many which often lead to real meetings and dates and subsequent productive and fulfilling relationships.

Online dating is booming worldwide, and many persons, of all ages, ethnic groups, and cultures, are turning to dating sites and applications, as well as social networking sites and applications, to connect with like-minded persons who share similar interests and objectives, and this form of virtual interaction also helps users and members gain more knowledge and insight about individuals, to establish a measure of rapport, and to gauge user compatibility, prior to actually meeting in person.

Virtual connections on dating and social networking sites and applications do not always provide clear reflections of members' personality traits, backgrounds, or even their physical features. Research shows that many members provide inaccurate information, including but not limited to age, appearance, education and income level, job status, country of origin, or even marital status. Many dating sites provide background and verification checks for members, and social networking and dating sites also utilize a plurality of authentication and verification software programs to filter out members and users, based on profiles comprising distinct factors, repetitive patterns that suggest red flags, verbiage clues and contextual predictors, that may signal said individuals to be potential scammers, spammers, unethical, and fraudulent. However, such programs that rely on data mining, automated or computer-generated background checks and analysis, and pattern recognition and contextual clues are not completely foolproof in eliminating said undesirable persons from sites, applications and platforms.

Mobile dating and location-based dating sites, platforms and applications, or what some refer to as proxidating or proximeeting, are becoming popular, especially among the younger demographic groups such as teens, university students, and singles in their 20s and 30s. These groups often are on the go, and their mobile communication devices are becoming their main tools for communication, interaction, entertainment, and information. Users of mobile dating and location-based dating sites and apps (i.e., applications) may receive notifications and alerts when someone who meets their criteria for a specified or desired relationship is in their general location, proximity or vicinity. Such sites and applications, which utilize matching algorithms and geo-targeting and geo-fencing for connecting users, provide a way for users to meet or connect with someone while on the go, often by impulse; however, said applications and platforms also can create potential risks and dangers, as users meet persons whom they have minimal or insufficient information about their backgrounds, personalities and traits. Often, these connections may be impulse encounters, and cognitive and decision skills also could be impeded due to situational and emotional factors, or tangible in nature, such as medical-related, or mental capacities which may be diminished through the intake of alcohol or recreational or prescription medication.

Location-based service and location-aware sites and applications and microblogging platforms enable users to provide ongoing real-time updates of what they are doing, where they are, and whom they are with, which convey and share said information to a plurality of selected friends and contacts. Often, other individuals, who may not be part of these users' social, professional or familial networks or inner circles, or who may no longer be part of the users' contact lists on said platforms referenced above, gain access to this private or confidential information. Such persons may use this information to commit unethical, unsolicited, or illegal acts, including but not limited to, targeting users for potential attacks or assaults, intruding on private events or encounters, or breaking into residences and offices, with the knowledge that nobody may be occupying or safeguarding the users' premises.

### REFERENCE PATENTS & PRIOR ART

U.S. Pat. No. 7,593,740 (Crowley, et al), expressly incorporated herein by reference, relates to a mobile location-aware system for a user sending a message to another user, who has a prior acquaintance relationship with the first user, based on proximity. This invention facilitates communication with friends and contacts based on location and proximity; and it enables mobile geo-notifications to said contacts, primarily for social interactions. This invention does not teach a method for facilitating the transmission of alerts or requests by users, to monitor safety or initiate alibi messaging, with other users, who have friendship or acquaintance relationship status, who are located nearby or who are in the vicinity of the user.

U.S. Pat. No. 7,450,015 (Singer, et al), expressly incorporated herein by reference, delineates a system and method for confirming the locations of individuals within designated areas. This invention relates to remote monitoring and activating sensors that ensure the safety of subjects, primarily elderly patients and individuals with chronic conditions. This invention does not teach a method for enabling subjects and users to set pre-determined messaging for friends and familial contacts to transmit communication at specified times and intervals, nor does it allow the subjects or users to create their own personalized messaging to be transmitted at scheduled times or intervals. This invention also does not teach a peer-to-peer network of close contacts to support their designated users, via notifications and messaging, during meetings and encounters with other individuals.

U.S. Pat. No. 5,119,346 (Henderson, et al), expressly incorporated herein by reference, relates to a portable apparatus, worn by a child, that sends alert notifications to signal a pre-determined message or reminder which is designed to initiate a response by the user. This invention does not teach a system and method for the users to select contacts or a peer network to remotely monitor them by transmitting messaging at intervals, nor does it allow the user to input the location coordinates prior to interacting with others for occasions, namely dates, encounters, and meetings.

### SUMMARY OF THE INVENTION

The invention provides a method and apparatus which comprises logging into an account, inviting a plurality of selected contacts from a user's directory that reside on, firmware, as well as a plurality of networks to perform the role of guardians or monitors during a date or encounter with an individual, or choosing a remote support worker to provide ongoing notifications, checking in and monitoring, including but not limited to transmitting messaging, calls, and alerting personnel in the event of a non-response from the users, inputting information and content about the said individual, providing details pertaining to the time and location of the scheduled meeting, and enabling selected contacts and support workers to store and utilize this information and data to facilitate the performance of their roles, namely escalating safety measures and alerting personnel to render assistance.

In another embodiment, the system provides a personalized interface for generating and inputting settings, including but not limited to, scheduling messaging at specified times and intervals, during the course of a date, encounter or meeting.

The invention facilitates capturing data and details pertaining to the persons whom the users will be meeting, the designated location coordinates, and the time and date of the scheduled meeting or date. Users may modify these settings after logging into their accounts from any global communication or wireless network, or portable or mobile wireless communication device, including but not limited to smartphones, PDAs, and tablets.

The following components of the invention also comprise the method and apparatus:
A peer-to-peer personalized method to receive and transmit messages at specified times, to identify selected contacts from a location-based networking application in the event of a potentially dangerous or serious encounter.
A self-generating messaging module enabling users to transmit automatic messaging at specified time and intervals.
A personalized system enabling users to identify messages from particular contacts based on sounds and ring-tones.
A method to generate a visual heat-map, to be viewed on global communication, wireless or mobile user interface, providing a visual representation of the users, on dates and meetings, generated either through the GPS coordinates of a user's location from a chip in said user's mobile communication device, which can be accessed and followed by a plurality of selected contacts, as well as contacts and friends who reside on the directories of users' networks, and, who at that particular time, are in the proximity of the venue wherein said user is meeting a person for a date or encounter.
A system and method to generate an alarm from a user's mobile communication device, based on a plurality of factors, including but not limited to, lack of a reciprocal response from said user, after contacts have transmitted a message wherein soliciting a request response, including but not limited to calls, text messaging, chat, and VoIP chat, whereby verifying the safety of said user.

Another embodiment of the invention enables the user to document a visual representation of the encounter or date with an individual, which can be sent in real-time to selected contacts, through capturing this event or meeting via image and video capturing and recording and visual capturing tools on mobile communication devices, or activation via a remote hardware tool such as a key fob.

Furthermore, the user may utilize a microblogging platform or location-based services application, integrated with the invention, to provide real-time updates and locations of meetings to selected contacts, as well as to nearby contacts in the users' directories that reside on these applications and platforms, wherein automatically sharing data and information about the user's location, or transmitting data, queries and requests via notifications and posts to a plurality of contacts that reside on a users' contact network directory, including but not limited to social media sites like Facebook, a microblogging platform like Twitter, a location-based platform like FourSquare, Loopt, BrightKite and Gowalla, or location-based apps that share the locations, checkins, posts, and real-time activities of selected contacts.

Another embodiment of the invention enables users to request selected guardians (i.e., contacts) to safeguard or monitor their residences during meetings and dates, in the event that individuals, including but not limited to followers, peripheral contacts or hackers, that have or gain access to a location-based service application or microblogging platform, attempt to utilize said information, including but not limited to notifications and updates provided by the users, for illegal or offensive purposes, namely breaking in and stealing items and possessions of the said users.

### BRIEF DESCRIPTION OF THE DRAWINGS

FIG. 1 is a flow chart depicting the overview of logging in the platform, inviting a plurality of selected contacts to be guardians, and capturing data about the profiles of the individuals whom the users will be meeting.

FIG. 2 is a flow chart delineating the interface and process for receiving accepted invites to be guardians from selected contacts, and choosing selected contacts to generate specific messaging at designated intervals, as well as transmitting significant information about the individual whom the user will be meeting. In the event, as can be viewed in the process, a sufficient number of contacts do not or cannot accept their roles to be guardians during this particular encounter, date, or meeting, said user may select other contacts from a plurality of directories, as well as utilizing the remote support workers to provide ongoing checking in with the users via messaging and calls, wherein said support workers will perform the role of guardians.

FIG. 3 is a flow chart depicting the personalized messaging that the user will receive during dates or encounters, either via selected contacts, or for self-generated messages to be transmitted at scheduled time and intervals.

FIG. 4 is a flow chart delineating the overview of the user inputting location coordinates, the specific time and date of the scheduled meeting or encounter.

FIG. 5 is a flow chart depicting the user receiving messaging and notifications from selected contacts at scheduled intervals, as well as self-generated messaging, including but not limited to texts, calls, and pings.

FIG. 6 is a flow chart delineating the process wherein the user will log into a location-based services or microblogging application or platform prior to a meeting or date, subsequently transmitting information, including location and updates, to a plurality of contacts that reside on the user's directories of said networks, platforms and applications.

FIG. 7 is a flow chart depicting the user capturing the real-time visual interaction with the individual during an encounter or date, with a mobile or handheld communication device, and simultaneously transmitting this encounter in real-time to selected contacts, including but not limited to the appointed guardians (i.e., contacts), or friends or contacts that may be in the vicinity of the event, meeting, or date, as well as to remote support workers.

FIG. 8 is a flow chart depicting selected guardians or contacts transmitting messages to the user. Upon not receiving an adequate response or a non-response after notification and messaging transmitted to the user, selected guardians may choose to: call or contact user, contact emergency services, utilize location coordinates or the captured profile data, to transmit to their own contacts in a location-based service application for peer-to-peer aid to facilitate help to the user, or to provide this data to emergency services. Moreover, appointed guardians, remote support workers, and a plurality of contacts that reside on a user's network directory also may utilize said information, including but not limited to location, situation, data, information, to render direct aid or to contact someone, for example, at the venue or in the vicinity of the date or meeting, to render assistance to the user who may be in danger or distress.

FIG. 9 depicts an apparatus, in this case, a Blue-tooth enabled key fob, for sending a signal to sound an alarm on the user's mobile or handheld communication device, in the event of distress, or if the user feels the situation or meeting with the individual poses potential danger. It also reflects a mobile communication device that can be programmed to automatically generate an alarm at a specified time in the event that the application is not deactivated by way of pressing a button, touch-screen, or a Blue-tooth enabled key fob, or it may automatically send notifications, including texts and messaging, to selected guardians, remote support workers, as well as to contacts and friends who are in the vicinity of the user, based on the geo-targetting of friends, family and contacts on a location-based application or platform.

### DETAILED DESCRIPTION OF THE PREFERRED EMBODIMENTS

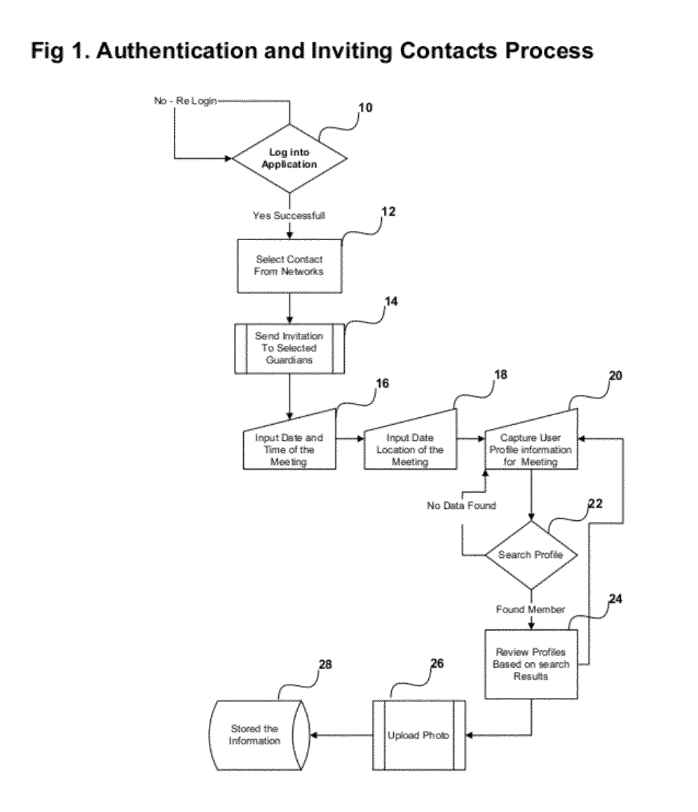

FIG. 1 depicts the overview of the user logging into the application 10 and then user selects a plurality of contacts from a database on the user's networks and platforms 12 and invites these selected contacts to be guardians 14. The user will input data about the time and date 16 and location 18 of the scheduled date with the user. The user will subsequently capture data about the intended person whom the user will be meeting 20, including photo and profile. The user also has the option to do a self-verification and authentication of the intended whom the person will be meeting by conducting a image search of the user's profile 22, and subsequently reviewing the profile with data provided by the intended person whom the user will be meeting 24, including data relating to appearance and comparing to the uploaded photo and 26 searching for key words provided by the intended person whom the user will be meeting. At this point, 28 the user will store this data about the individual.

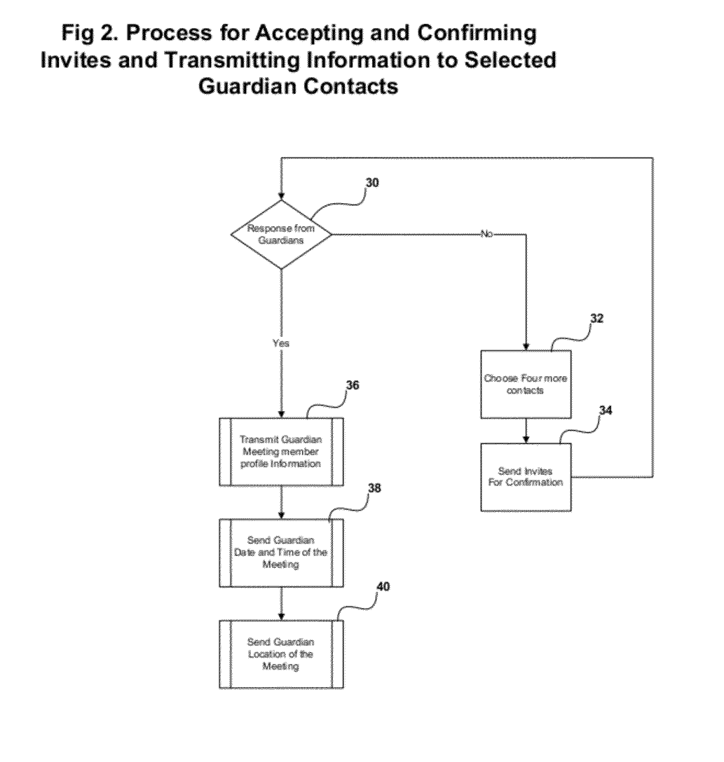

FIG. 2 delineates how the user will check on what, if any responses, for the solicited requests to be guardians 30. If the user has not received four confirmations to be guardians, the user has the option to choose more contacts, with the caveat to accept a maximum of four guardians for a particular meeting or date 32. Upon identifying and confirming the guardians 34, the user will transmit details about the designated meeting or date, including information, including profile and photo, about the intended person whom the user will be meeting 36, the time and date of the intended meeting and date 38, and the specific location of the scheduled meeting or encounter 40.

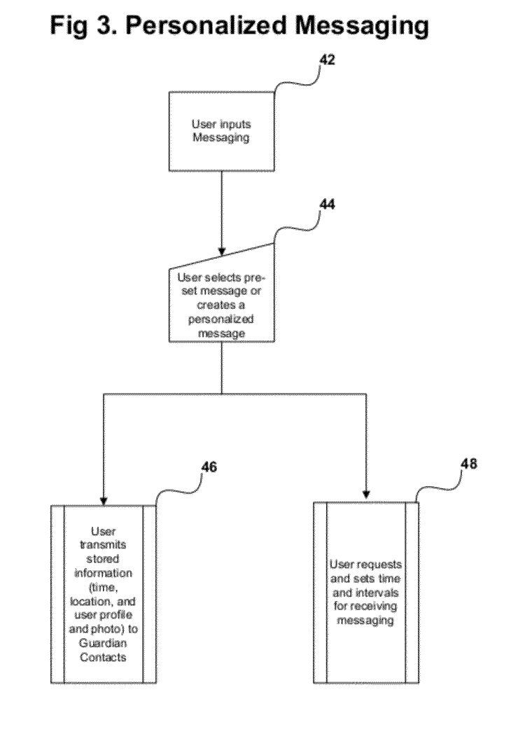

FIG. 3 depicts the messaging process that the user will input 42, either through pre-set messages or personalized, which the user will transmit to selected contacts or guardians 44, who will send to the user at scheduled times and intervals 46, as well as self-generated messages that the user will create and set for delivery 48, at specified times and intervals.

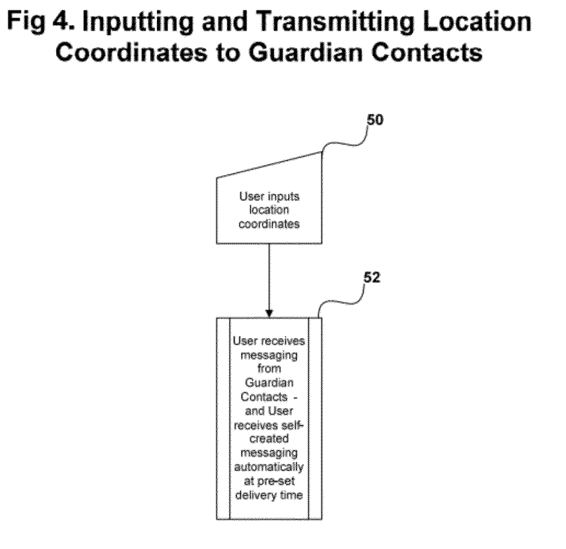

FIG. 4 depicts the process that the user will input information for storage and transmittance to selected contacts, including the location coordinates of the intended meeting 50, and the specified date and time, including time zone, for the user to receive messaging and notifications from selected contacts 52, on a mobile, wireless or handheld communication device.

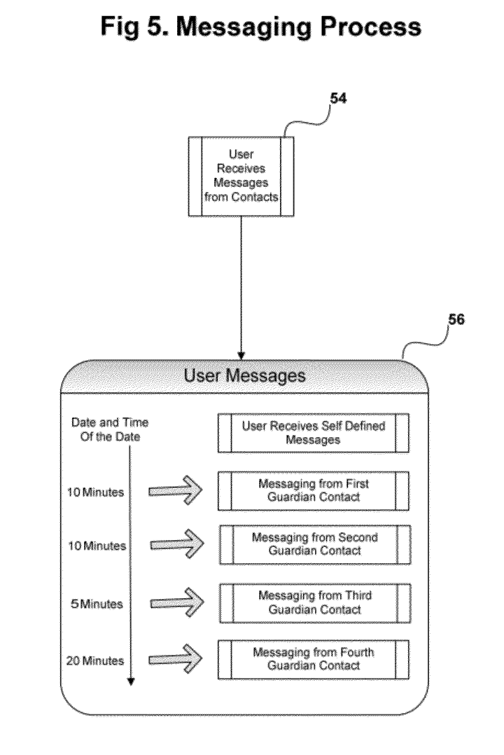

FIG. 5 depicts the overview and process on the interface of the mobile, wireless and handheld communication device receiving messaging and notifications from selected contacts at various times and intervals 54, as well as a self-generated automatic text message at a pre-determined time 56.

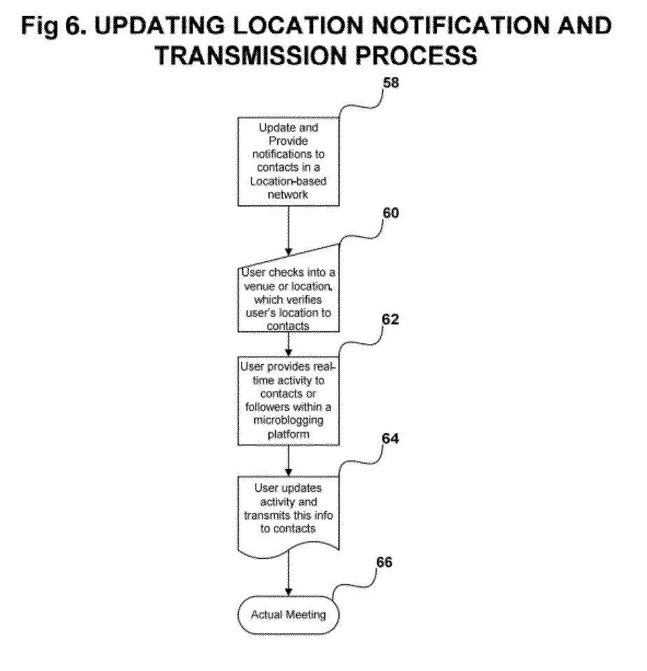

FIG. 6 depicts the process wherein the user logs into a location-based application 58 prior to checking into a location, informing selected contacts that the user has checked in to that location 60. The user subsequently shall log into a microblogging platform 62 to provide updates to contacts and followers 64 prior to the actual meeting, date or encounter 66.

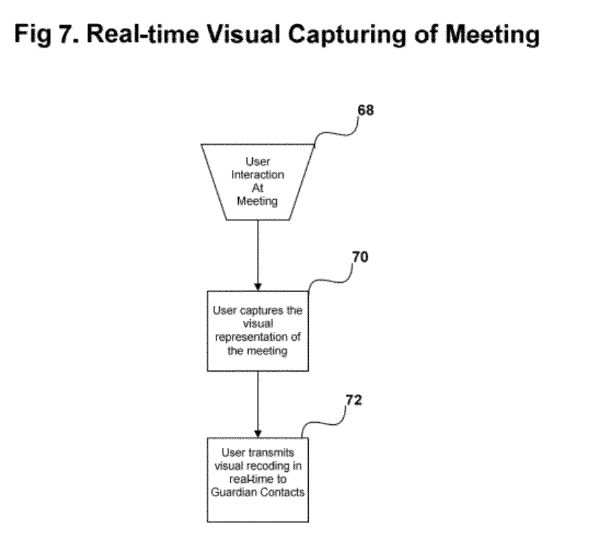

FIG. 7 depicts the process of a user interacting with the intended person whom he or she is meeting 68 at a location, while simultaneously visually recording the meeting with a mobile, wireless, or handheld communication device 70, and at the same, transmitting a visual representation of said meeting in real-time to selected contacts 72.

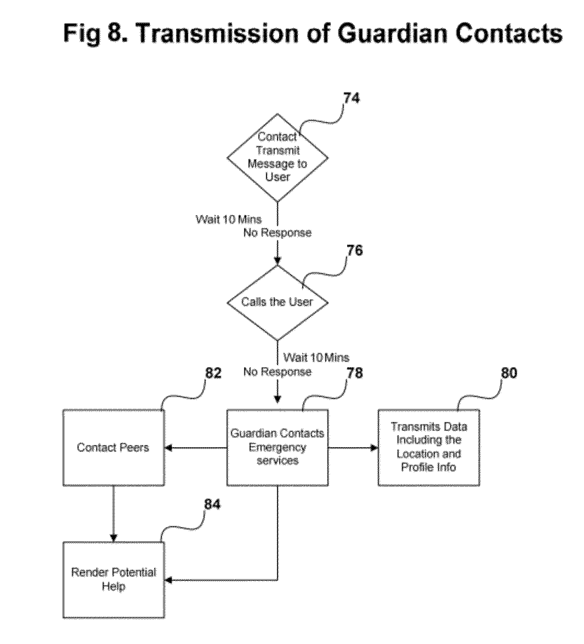

FIG. 8 delineates an overview of the process wherein selected contacts transmit messaging to the user 74. If they do not receive a response or the response is inadequate or warrants an alarm, any or all selected contacts in their roles of guardians will first call the user 76. If there is no communication or the response is inadequate or unacceptable or ambiguous, selected guardians will contact emergency services 78 and transmit data, including location coordinates, user profile, and the profile of the designated person whom the user is meeting 80. At this point, selected guardians also may contact peers 82 that are located near the user to find and render potential aid 84.

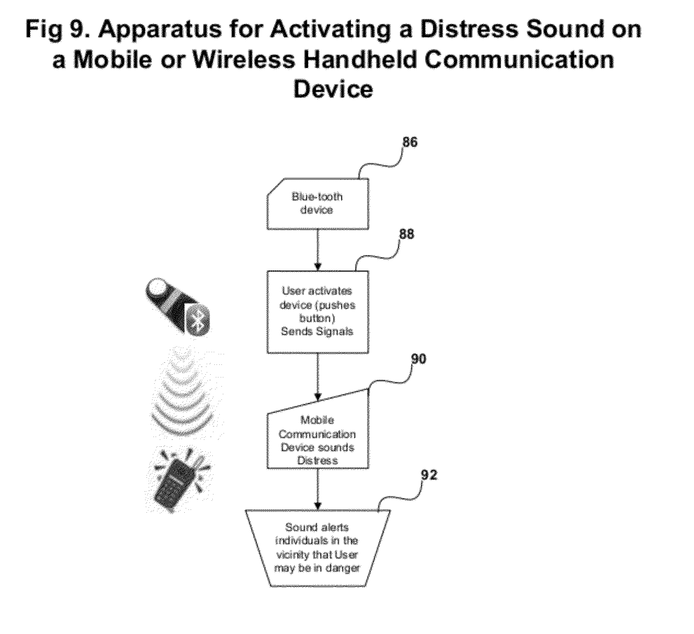

FIG. 9 depicts the apparatus 86 worn by the user to automatically sound an alarm, via a Blue-tooth connection, on the user's handheld, wireless, or mobile communication advice 88. The user also may activate a pre-recorded message of distress 90, wherein individuals in the vicinity may respond to the message 92 and take action.

The invention claimed is:

1. A method for authenticating and verifying a person's profile within an online dating, social networking, location-based services site, platform or application, comprising:
Comparing the person's profile with the s person's self-provided description;
Searching for key words in a person's profile's description that may trigger clues to inaccuracies;
Utilizing a support group that has access to the site, application, or platform database, as well as a peer group of contacts, to verify data and information, including but not limited to country of origin or location by way of IP address, profile info wherein searching a database of photos often used by scammers, and identifying contextual clues in the profile's verbiage that often trigger red flags and suggest a potential scammer;
Capturing the user's profile and utilizing that image on a search engine in the category of images, or conducting a visual search comprising a database of fake profiles, scammers, and fraudulent and deceitful individuals;
Contacting other members who have interacted with said individual, or contacting a database support worker to request information about said individual;
Requesting the host or technical support of an application, platform or website to verify and check if the user's profile which includes his or her country of origin matches the country or location of the IP address captured upon registration.
The method of claim 1, wherein said storage information and content about a particular member or user of a social media or online dating application, platform or website, is determined using database mining, pattern analysis, and location via geo-fencing in combination with a wireless network.

2. A method for selecting a plurality of prospective guardians or supporters from personalized directories that reside on a user's network and firmware, including but not limited email accounts, microblogging and location-based service platforms, and social media apps and websites, to engage in monitoring and messaging during a user's encounter or date with an individual.
The method of claim 2, wherein users select contacts from their networks' directories and send invitations or requests to perform the role of guardian or supporter, during designated times and to send messaging at scheduled times and intervals.
The method of claim 2, further comprising a user selecting a plurality of contacts, who are in or will be in the vicinity of the scheduled date, encounter, or meeting, from location-based service applications and microblogging platforms to transmit information about a user's location and periodic updates in real-time.
The method of claim 2, further comprising the user transmitting information and content pertaining to a person's profile, the scheduled day and time for the meeting or encounter, and the designated location for the meeting or encounter.
The method of claim 2, wherein said location and said user and said person whom the user will be meeting are generated utilizing geo-targeting or geo-fencing, via an advanced geo-mapping system in combination with a wireless network.
The method claim 2, wherein a user's plurality of contacts receive updates and notifications about the user's activities and for said contacts who are within the vicinity of the user's designated location for the encounter or meeting, to engage in a peer-to-peer buddy system to facilitate a safer meeting or encounter, or provide greater peace of mind for the user, while knowing that contacts are nearby if said user is in distress relating to the said encounter or meeting, and that said nearby contacts may render or facilitate aid in the event of a potentially dangerous encounter.
The method of claim 2, wherein the user selects a specific locale or venue for the designated meeting or encounter, after receiving notification that a user's contact(s) will be in the identical location or at a nearby locale or venue.
The method of claim 2, further comprising the user providing the contact number and location of said venue or place for the designated meeting or encounter to a plurality of selected contacts.
The method of claim 2, wherein a user may check in to a venue, locale, or establishment and post this information to a platform or network for a plurality of selected user contacts to view.

3. A method for requesting messaging and communication from selected contacts or supporters, and the type of message or communication and at what specified times and intervals during a date or encounter, to receive said messaging and communication.
The method of claim 3, wherein a user pre-sets a self-generated message, which may include but not be limited to a call, chat or text message, and pre-set for delivery at a specific time during a date, meeting or encounter with an individual.
The method of claim 3, further comprising a way for users to set incoming messaging, including texts or calls, with specific ring-tones.
The method of claim 3, wherein a user may activate a distress alert or notification to friends and contacts wherein a location-based application network or platform reflects that said contacts are in the vicinity of the user.
The method of claim 3, wherein a user may request a guardian to provide continual monitoring or to safeguard the user's residence, once a network of individuals, including but not limited to followers, persons utilizing the same network of contacts, are cognizant of the user's whereabouts and real-time activities and feeds and posts.
The method of claim 3 which utilizes an algorithm for transmitting automated messaging to a plurality of contacts that reside on a user's directory of networks, as well as to remote support workers, in the event that certain factors, including but not limited to a non-response from the user, an inability to locate and establish communication with said user, or data that reveals the person whom the user is meeting has been determined to be deceitful, fraudulent, or dangerous.
The method of claim 3, further comprising specified actions for guardians and supporters to take in the event that they have received no response from the user, or the communication from the user suggests potential danger, red flags or distress.
The method of claim 3, wherein a user may pre-set the sounding of an alarm on a mobile, wireless, or handheld communication device at a particular time, with a pre-recorded distress message delivered at this specified time.
The method of claim 3, further comprising prioritizing and escalating messaging and notifications to a user's directory of contacts, who are in the vicinity of the user's scheduled meeting and encounter, with concomitant messaging and notifications to personnel who work at the locale, establishment or venue of the meeting.

4. What is claimed: An apparatus for transmitting signals, via Blue-tooth, for example, a key fob, to activate a mobile, wireless, or handheld device, which subsequently sends and transmits a distress call or messaging to a plurality of selected contacts and remote support personnel who are designated user guardians.
The method of claim 4, wherein the user's location may be indentified and calculated via a heat-map visual representation in real-time.
The method of claim 4, further comprising an apparatus that activates a wireless signal to send pre-created distress messages, from a mobile communication device, to emergency services.

5. What is claimed: An apparatus for visually recording an encounter with an individual and transmitting said visual representation to a plurality of selected contacts and remote support workers.
The method of claim 5, wherein the user may utilize the apparatus to video capture a meeting in real-time and simultaneously transmit said visual representation of the date, encounter, and meeting.
